(19) United States
(12) Patent Application Publication
(10) Pub. No.: US 2007/0061583 A1
(43) Pub. Date: Mar. 15, 2007

(54) IMAGE PROCESSING METHOD, IMAGE PROCESSING APPARATUS, AND STORAGE MEDIUM

(75) Inventors: Tomotoshi Kanatsu, Tokyo (JP); Junichi Hayashi, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/468,004

(22) Filed: Aug. 29, 2006

(30) Foreign Application Priority Data
Sep. 9, 2005 (JP) 2005-262655

(51) Int. Cl. H04L 9/00

(52) U.S. Cl. 713/176

(57) ABSTRACT

An image processing method is provided to control an action for image data based on control information associated with the image data. The method includes generating an electronic signature to be affixed to image data, and generating control information used for controlling an action for the image data based on a result of verification of the electronic signature. The method further includes integrating the image data, the electronic signature, and the control information to generate integrated data and transmitting the integrated data.

### BACKGROUND OF THE INVENTION

1. Field of the Invention

The present invention relates to technologies involved in electronic signatures to images.

2. Description of the Related Art

A variety of information, including character data, video data, and audio data, has been digitized along with rapid development and proliferation of computers and computer networks in recent years. Digital data is not deteriorated due to, for example, aging and can be stored in perfect condition while it can be easily reproduced, edited, or processed. Although the easy reproduction, editing, and processing of such digital data are very useful for users, protection of the digital data becomes a major issue.

A technology called electronic signature is proposed, which is used by a user to determine whether data that is transmitted is altered (e.g., falsified). The electronic signature is additional data for prevention of the alteration (e.g., falsification) of original data. The electronic signature technology has an effect on not only the determination of the alteration of original data but also prevention of spoofing or denial on the Internet.

Providing an apparatus that processes an electronic document (e.g., video data) with a function of verifying the electronic signature allows the apparatus to verify the electronic signature to determine whether the electronic document is reliable before processing the electronic document. In addition, it is possible to realize an apparatus capable of changing the action for the electronic document in accordance with the result of the determination.

US Patent Publication No. 2002-0080959 discloses a technology of adding a certification mark to an electronic document and printing the electronic document with the certification mark added if the verification of the electronic signature succeeds or printing the electronic document without the certification mark if the verification of the electronic signature fails.

However, in the technology disclosed in US Patent Publication No. 2002-0080959, determination of how to process the data after verifying the electronic signature affixed to data, such as the electronic document, depends on a verifier (a person who verifies the electronic signature) of the electronic signature or the verification apparatus. In other words, the data may not be processed as intended by a signer (a person who generates the electronic signature) after the electronic signature is verified. Accordingly, the verifier may be able to print the falsified electronic document despite the fact that the signer wanted to prevent the altered (e.g., falsified) electronic document from being printed. Furthermore, it is not easy to change the manner in which the electronic document or partial images in the electronic document is processed or controlled after the verification.

### SUMMARY OF THE INVENTION

An embodiment of the present invention provides a method capable of enabling an execution of a process (e.g., an action) as intended by a signer after an electronic signature affixed to an electronic document is verified.

An embodiment of the present invention also provides a method of generating image data with an electronic signature, to which a process (e.g., action) as intended by the signer can be performed.

According to an embodiment of the present invention, an image processing method includes generating an electronic signature to be affixed to image data, and generating control information used for controlling an action for the image data based on a result of verification of the electronic signature. The method further includes integrating the image data, the electronic signature, and the control information to generate integrated data and transmitting the integrated data.

According to another embodiment of the present invention, an image processing method includes receiving image data, an electronic signature affixed to the image data, and control information, and verifying the electronic signature based on the image data and the electronic signature. The method further includes controlling an action for the image data based on the control information and a result of verification of the electronic signature.

According to yet another embodiment of the present invention, an image processing apparatus includes an electronic signature generating unit, a control information generating unit and a transmitting unit. The electronic signal generating unit is configured to generate an electronic signature to be affixed to image data. The control information generating unit is configured to generate control information used for controlling an action for the image data based on a result of verification of the electronic signature. The transmitting unit is configured to integrate the image data, the electronic signature, and the control information to generate integrated data and to transmit the integrated data.

According to further another embodiment of the present invention, an image processing apparatus includes a receiving unit, an electronic signature verifying unit and a controlling unit. The receiving unit is configured to receive image data, an electronic signature affixed to the image data, and control information. The electronic signature verifying unit is configured to verify the electronic signature based on the image data and the electronic signature. The controlling unit is configured to control the action for the image data based on the control information and a result of the verification of the electronic signature in the electronic signature verifying unit.

Further features of the present invention will become apparent from the following description of exemplary embodiments with reference to the attached drawings. It is noted that the references to “an” or “one” embodiment of this disclosure are not necessarily directed to the same embodiment, and such references mean at least one.

### BRIEF DESCRIPTION OF THE DRAWINGS

FIG. 1 is a schematic diagram of a system to which embodiments of the present invention can be applied.

FIG. 2 is a block diagram showing an example of components of a host computer according to an embodiment of the present invention.

FIG. 3 shows an example of a functional configuration according to a first embodiment of the present invention.

FIG. 4 is a flowchart showing a process performed by a structured data generator according to the first embodiment of the present invention.

FIG. 5A shows an example of a paper document to be digitized and FIG. 5B shows an example of area division.

FIG. 6 is a diagram illustrating an information adder according to an embodiment of the present invention.

FIG. 7 is a diagram schematically showing an example of an electronic document integrated by an electronic document integrator.

FIG. 8 shows an example of control information according to the first embodiment of the present invention.

FIG. 9 shows another example of the control information according to the first embodiment of the present invention.

FIG. 10 shows an exemplary tree structure of structured data.

FIG. 11 is a flowchart showing a process performed by a control information interpreter and an action performer.

FIG. 12 shows an output example when verification of an electronic signature on the basis of the control information in FIG. 8 fails.

FIG. 13 shows an output example when the verification of the electronic signature on the basis of the control information in FIG. 9 succeeds.

FIG. 14 shows an example of a user interface for setup of the control information.

FIG. 15 schematically shows a system according to a second embodiment of the present invention.

FIG. 16 is a block diagram showing an example of the functional configuration according to the second embodiment of the present invention.

FIG. 17 shows an example of control information according to the second embodiment of the present invention.

FIG. 18 is a diagram schematically showing a process of generating the electronic signature and a process of verifying the electronic signature.

FIG. 19 shows an example of a user interface for selection.

### DESCRIPTION OF THE EMBODIMENTS

First Exemplary Embodiment

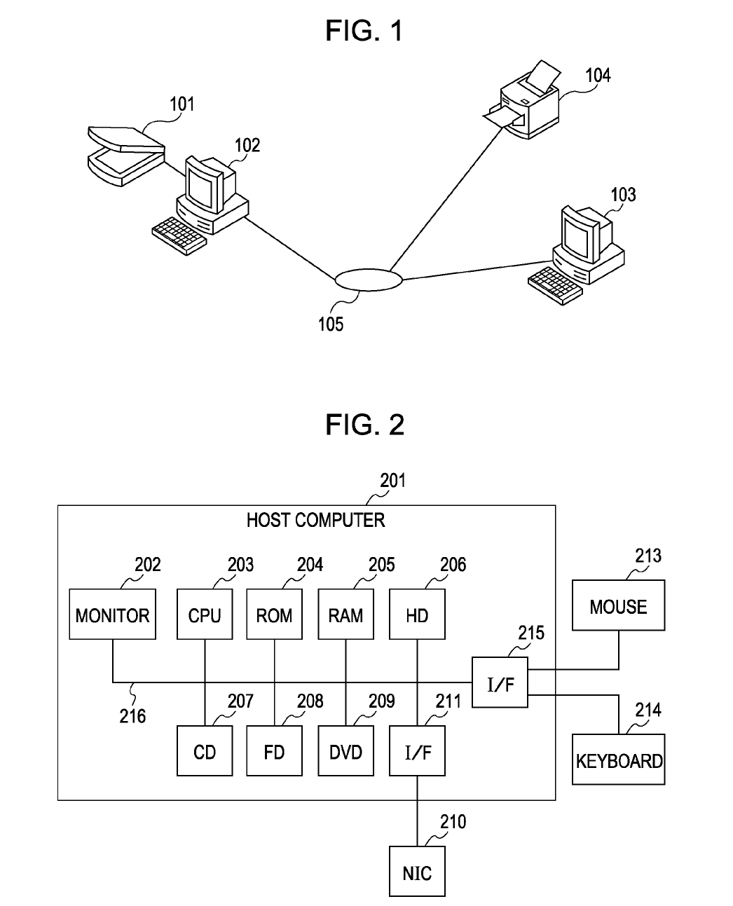

FIG. 1 is a schematic diagram of a system to which embodiments of the present invention can be applied. Referring to FIG. 1, the system includes a scanner 101 that converts information on a paper document into image data, a computer 102 that generates an electronic document (image data), a computer 103 that verifies an electronic signature affixed to the electronic document and generates print data, and a printer 104 that prints an image represented by the print data. The scanner 101, the computer 102, the computer 103, and the printer 104 are connected to each other via a network 105. Although the system includes the four apparatuses in FIG. 1, the present invention is not limited to such configuration. For example, a single apparatus (a high-performance scanner or a copier) including the functions of the scanner 101 and the computer 102 may be replaced with the scanner 101 and the computer 102. Similarly, a single apparatus (a high-performance printer or copier) including the functions of the computer 103 and the printer 104 may be replaced with the computer 103 and the printer 104.

A host computer 201 according to an embodiment of the present invention will be described with reference to a block diagram shown in FIG. 2.

FIG. 2 shows an example of the basic components of the host computer 201 and the relationship between the host computer 201 and peripheral devices. The host computer 201 is applicable to an electronic document generating apparatus 301 and an electronic document processing apparatus 302, described below. The host computer 201 is, for example, a common personal computer. The host computer 201 includes a monitor 202 that displays a variety of information supplied from the host computer 201.

The host computer 201 also includes a central processing unit (CPU) 203, a read only memory (ROM) 204, and a random access memory (RAM) 205. The CPU 203 controls the components in the host computer 201 and executes programs loaded in the RAM 205. The ROM 204 stores a basic input/output system (BIOS) and a boot program. The RAM 205 temporarily stores programs and image data to be processed in the CPU 203. The programs used by an operating system (OS) or the CPU 203 to perform various processes described below are loaded in the RAM 205.

The host computer 201 further includes a hard disk (HD) 206, a compact disk-read only memory (CD-ROM) drive 207, and a floppy disk (FD) drive 208. The HD 206 stores the OS and the programs to be transferred to the RAM 205 and the like. The image data is stored in and read out from the HD 206 while the apparatus is running. The CD-ROM drive 207 reads out data stored in a CD-ROM (or a compact disk recordable (CD-R)), which is an external storage medium, and writes the data in the CD-ROM (or CD-R). The FD drive 208 reads out data stored in a FD and writes the data in the FD, like the CD-ROM drive 207.

The host computer 201 further includes a digital versatile disk-read only memory (DVD-ROM) (digital versatile disk-random access memory (DVD-RAM) drive 209. The DVD-ROM (DVD-RAM) drive 209 reads out data stored in a DVD-ROM and writes the data in a DVD-RAM, like the CD-ROM drive 207. When programs for image processing are stored in the CD-ROM, the FD, the DVD-ROM, or the like, the programs are installed in the HD 206 and are transferred to the RAM 205, if necessary.

The host computer 201 further includes an interface (I/F) 211 and an interface (I/F) 215. The I/F 211 interfaces between the host computer 201 and a network interface card (NIC) 210 connected to a network, such as the Internet. The host computer 201 transmits and receives data to and from the Internet through the I/F 211. The I/F 215 interfaces between a mouse 213 or a keyboard 214 and the host computer 201. Various instructions input with the mouse 213 or the keyboard 214 are supplied to the CPU 203 through the I/F 215.

The host computer 201 is capable of storing the image data in the HD 206, the CD-ROM, the FD, and the DVD and displaying the stored image data in the monitor 202.

The host computer 201 is also capable of using the NIC 210 to deliver the image data over the Internet. The various instructions etc. issued from a user are input with the mouse 213 and the keyboard 214. Blocks, described below, in the host computer 201 are connected to each other via a bus 216 to transfer a variety of data.

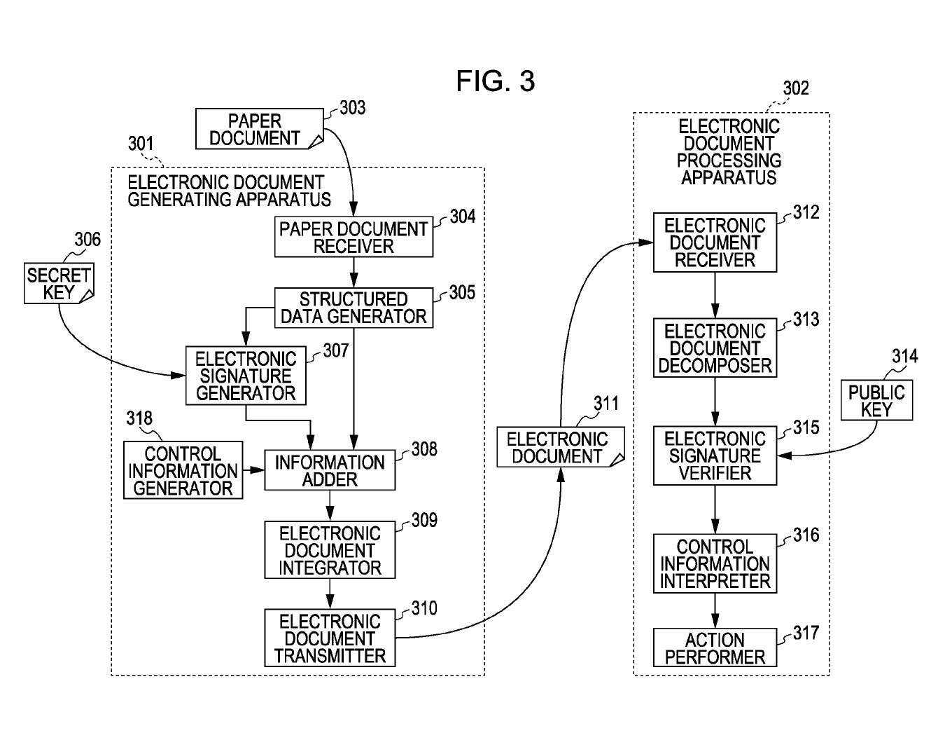

FIG. 3 shows an example of a functional configuration according to a first embodiment of the present invention. The first embodiment of the present invention includes the electronic document generating apparatus 301 and the electronic document processing apparatus 302.

The electronic document generating apparatus 301 includes a paper document receiver 304, a structured data generator 305, an electronic signature generator 307, a control information generator 318, an information adder 308, an electronic document integrator 309, and an electronic document transmitter 310. The paper document receiver 304 receives a paper document 303. The structured data generator 305 analyzes the paper document 303 to generate structured data. The electronic signature generator 307 generates an electronic signature by the use of the structured data and a secret key 306 (e.g., private key). The control information generator 318 generates control information used for controlling an action associated with an electronic document. The control information generator 318 may include a display unit in which the control information is displayed. The information adder 308 associates the control information acquired from the control information generator 318 and the electronic signature acquired from the electronic signature generator 307 with the structured data. The electronic document integrator 309 integrates the structured data, the electronic signature, and the control information with each other to generate an electronic document 311. The electronic document transmitter 310 transmits the electronic document 311 to the electronic document processing apparatus 302.

The electronic document processing apparatus 302 includes an electronic document receiver 312, an electronic document decomposer 313, an electronic signature verifier 315, a control information interpreter 316, and an action performer 317. The electronic document receiver 312 receives the electronic document 311. The electronic document decomposer 313 decomposes the integrated electronic document 311 to acquire the structured data, the electronic signature, and the control information. The electronic signature verifier 315 verifies the electronic signature on the basis of the structured data, the electronic signature, and a public key 314. The control information interpreter 316 interprets the control information. The action performer 317 processes, edits, or prints the decomposed electronic document in accordance with the verification result of the electronic signature and the control information.

The above blocks will be described in more detail below.

First, the blocks in the electronic document generating apparatus 301 will be described.

The paper document receiver 304 receives the paper document 303 to digitize the paper document into image data with the scanner 101 having a photoelectric conversion function.

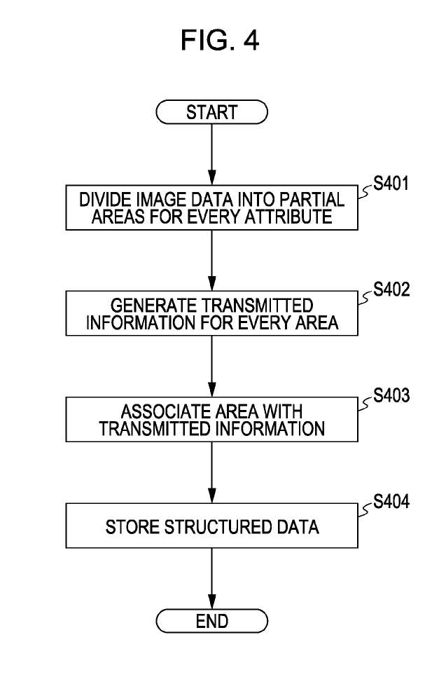

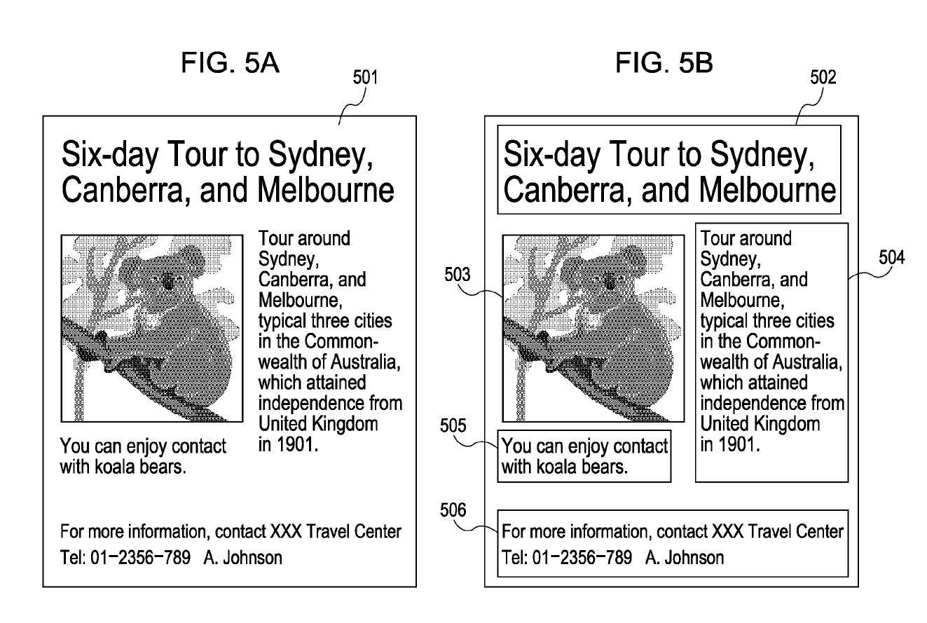

The structured data generator 305 will be described in detail with reference to FIG. 4 and FIGS. 5A and 5B. FIG. 4 is a flowchart showing a process performed by the structured data generator 305 according to the first embodiment of the present invention.

FIG. 5A shows an example of a paper document (image) to be digitized. Referring to FIG. 4, in Step S401, the process divides the image corresponding to one screen into a number of partial areas (partial images) on the basis of the attributes of the areas. Each partial area is a collection of continuous areas having the same attribute in an image. The attribute may indicate a type of the image, that is, a characteristic such as a character, a picture, a table, or a line drawing. A suitable method of dividing the image into the partial areas may be utilized. For example, a collection of clusters of black pixels or clusters of white pixels in a document image can be detected to extract areas having characteristic names including a character, a picture or drawing, a table, a frame, and a line from characteristic amounts including a shape, a size, and a collection state.

FIG. 5B shows a digitized document after dividing the document in FIG. 5A into a number of partial areas (acquisition of the partial areas) by determining the attribute of each partial area on the basis of the characteristic amount extracted from the image data representing the image corresponding to the document in FIG. 5A. Referring to FIG. 5B, partial areas 502, 504, 505, and 506 have a character attribute and a partial area 503 has a color picture attribute.

As the result of the area division in Step S401, the process generates structural information. The structural information indicates the attribute of each partial area given by the area division and layout information, for example, the positional coordinate in the image corresponding to the above screen.

In Step S402, the process generates transmitted information for every partial area yielded in Step S401. The transmitted information is image information required for rendering of the partial area. In an embodiment, if the partial area includes a picture or a natural image, the image information corresponding to the partial area is color raster data or monochrome raster data. If the partial area includes a line drawing or characters, the image information is vector data resulting from vector representation of the outline of an object in the area. If the partial area includes characters, the image information is text information including the position of each character code as a result of character recognition and font information. However, the transmitted information is not limited to the above examples and another information yielded from the original image information may be used as the transmitted information. For example, if the partial area includes characters, audio information resulting from electronic pronunciation of the characters included in the partial area may be used as the transmitted information.

According to the first embodiment of the present invention, if the electronic document generating apparatus 301 receives the image data representing the image shown in FIG. 5A, the vector data is generated in the character areas 502, 504, 505, and 506 in FIG. 5B and the color raster data is generated in the color picture area 503 in FIG. 5B as the transmitted information.

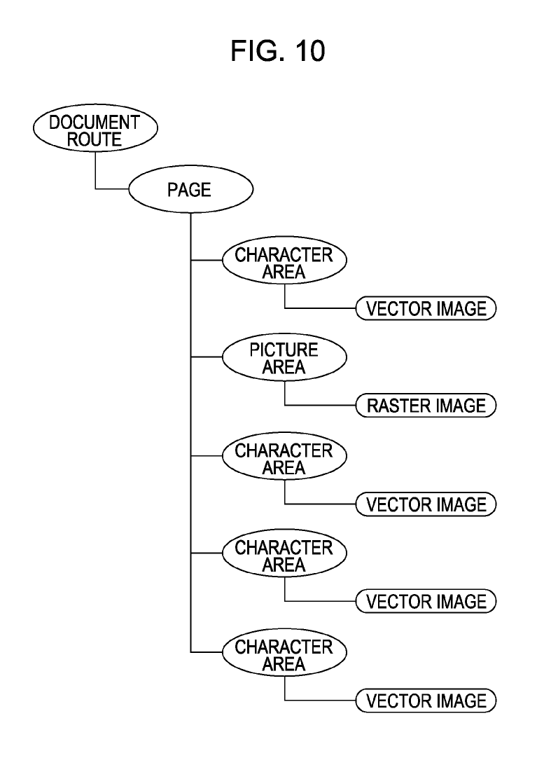

In Step S403, the process associates the structural information generated in Step S401 with the transmitted information generated in Step S402. The associated information is described in a tree structure, as the one shown in FIG. 10.

In Step S404, the process stores the generated data groups as the structured data. The data groups are stored in a format that can be represented in the tree structure shown in FIG. 10. According to the first embodiment of the present invention, the data groups are stored in an extensible markup language (XML) format.

The electronic signature generator 307 in FIG. 3 will now be described with reference to FIG. 18. The electronic signature generator 307 generates an electronic signature to be affixed to the structured data by using a method of generating the electronic signature.

FIG. 18 is a diagram schematically showing a process of generating the electronic signature and a process of verifying the electronic signature. A hash function and a public key cryptosystem are used in the generation of the electronic signature. Referring to FIG. 18, reference numeral 1806 denotes a secret key and reference numeral 1811 denotes a public key. A transmitter performs a hash process 1802 to input data 1801 to calculate a digest value 1803, which is fixed length data. Then, the transmitter performs a conversion process 1804 to the fixed length data with the secret key 1806 to generate signature data 1805 and transmits the signature data 1805 and the input data 1801 to a receiver. In a verification process 1812, the receiver verifies whether the data resulting from a conversion (decryption) process for signature data 1810 (the same as the signature data 1805) with the public key 1811 coincides with a digest value 1809 resulting from a hash process 1808 for input data 1807. If a verification result 1813 is affirmative, the receiver determines that the input data 1807 is not falsified. If the verification result 1813 is negative, the receiver determines that the input data 1807 is falsified.

In the process of generating the electronic signature in FIG. 18, the electronic signature generator 307 performs the hash process 1802 to the transmitted information, which is the input data 1801, to calculate the digest value 1803, which is fixed length data. Then, the electronic signature generator 307 performs the conversion process 1804 to the digest value 1803 by using the secret key 306 in FIG. 3 as the secret key 1806 to generate the signature data 1805.

The electronic signature may be generated from all the transmitted information in the structured data or may be generated from any part of the transmitted information in the structured data. In addition, the electronic signature may be generated for the structural information. Although the signature data described in the XML format is used as the electronic signature data in the first embodiment of the present invention, the electronic signature may be described in another format.

The secret key 306 supplied to the electronic signature generator 307 may be selected from multiple secret keys that are stored in advance by the signer of the electronic document in a storage unit (for example, the HD 206), which is hardware, in the electronic document generating apparatus 301. Alternatively, the secret key 306 may be read from a storage medium, such as an IC card, connected to the electronic document generating apparatus 301.

The control information generator 318 in FIG. 3 will now be described. The control information generator 318 generates information (control information) used for controlling the action performed by the electronic document processing apparatus 302 after the electronic signature is verified.

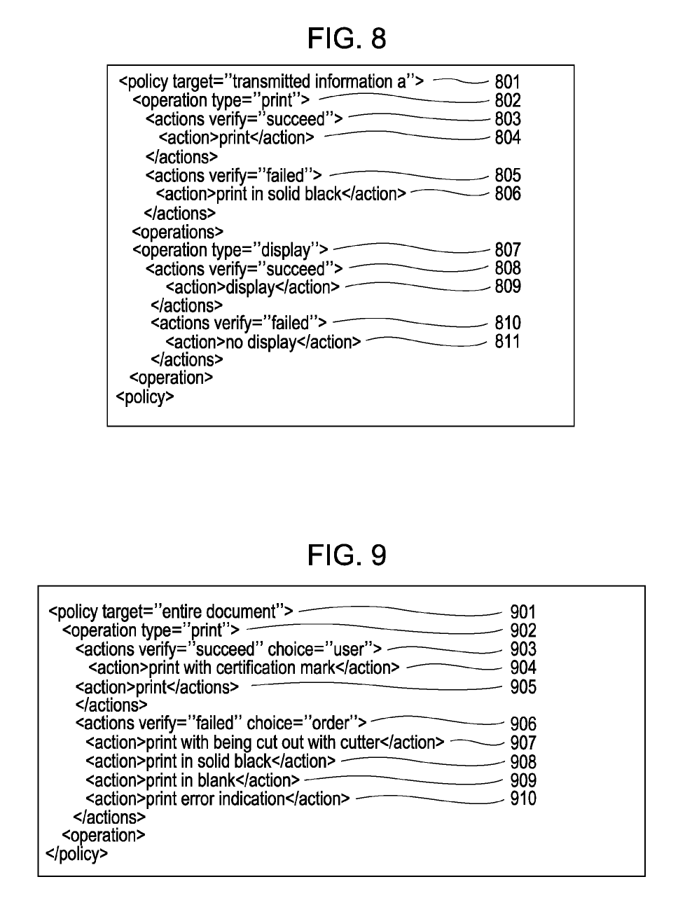

The control information is grouped into the following three types. The information of the first type indicates an operation type which the electronic document processing apparatus 302, which has received the electronic document, possibly performs to a partial area to which the electronic signature is affixed (signed area) in the electronic document. For example, this operation type corresponds to printing or displaying of the image represented by the input data. Specifically, the operation type corresponds to elements 802 or 807 in FIG. 8, which will be described in more detail below. The information of the second type indicates an action which the electronic document processing apparatus 302 performs in the above operation if the verification of the electronic signature succeeds. For example, in the printing operation, the information of the second type corresponds to a choice indicating how to print the image represented by the input data as a normal image. Specifically, the information of the second type corresponds to elements 803 and 804 in FIG. 8, which will be described in more detail below. The information of the third type indicates an action which the electronic document processing apparatus 302 performs if the verification of the electronic signature fails. For example, in the printing operation, the information of the third type corresponds to a choice indicating how to process the image represented by the input data as an abnormal image (altered image). Specifically, the information of the third type corresponds to elements 805 and 806 in FIG. 8, described below. The electronic document processing apparatus 302 may have one or more choices of the action if the verification of the electronic signature succeeds or fails. When the electronic document processing apparatus 302 has multiple choices of the action, the user of the electronic document processing apparatus 302 may manually specify an action to be performed, or an action to be performed may be automatically or manually selected in the order of priority set in advance. The user can make a choice with the mouse 213 or the keyboard 214 while viewing the monitor 202 of the host computer 201 applied to the electronic document processing apparatus 302.

The control information is not limited to the above three types. For example, only the control information if the verification of the electronic signature fails may be provided or only the control information if the verification of the electronic signature succeeds may be provided. Alternatively, the user may select a type of the control information.

FIG. 8 shows an example in which the control information is described as text data in the XML format. Referring to FIG. 8, reference numeral 801 denotes an element describing that “transmitted information a” is targeted at. The element 801 includes elements 802 and 807 describing operation types when the user processes the target transmitted information. Reference numeral 802 denotes an element describing that the target image is to be printed. The element 802 includes elements 803 and 805 describing that the verification of the electronic signature affixed to the target image succeeds and fails, respectively. Reference numeral 803 denotes a description if the verification of the electronic signature succeeds and includes an element 804 describing an instruction to print the target image. Reference numeral 805 denotes a description if the verification of the electronic signature fails and includes an element 806 describing an instruction to black out and print the target image. Reference numeral 807 denotes an element describing that the target image is to be displayed. Reference numeral 808 denotes a description if the verification of the electronic signature succeeds and includes an element 809 describing an instruction to display the target image. Reference numeral 810 denotes a description if the verification of the electronic signature fails and includes an element 811 describing an instruction not to display the target image.

Although the “transmitted information a” is targeted at in the above description, it is possible to perform the control for every transmitted information by describing the control information for “transmitted information b”.

FIG. 9 shows another example of the control information described as text data in the XML format. Referring to FIG. 9, reference numeral 901 denotes an element describing that the signed areas (the partial areas to which the electronic signature is affixed) in the entire electronic document (image data) is targeted at. Reference numeral 902 denotes an element describing that the target signed area is to be printed. Reference numeral 903 denotes a description if the verification of the electronic signature affixed to the target signed area succeeds and includes elements 904 and 905 describing instructions selected by the user. Reference numeral 904 denotes an element describing an instruction to add a certification mark, indicating that the verification of the electronic signature succeeds in the signed area, to the image displayed in the signed area where the verification of the electronic signature succeeds and to print the image with the certification mark being added. Reference numeral 905 denotes an element describing an instruction to print the image with nothing being added to the displayed image. Reference numeral 906 denotes a description if the verification of the electronic signature affixed to the target signed area fails and includes elements 907 to 910 describing instructions that are performed by the verification apparatus. The instructions 907 to 910 are described in the order of priority. Reference numeral 907 denotes an element describing an instruction to cut out with a cutter (cutting means) only the signed area where the verification of the electronic signature fails, in the electronic document, and to print the cutout area. Reference numeral 908 denotes an element describing an instruction to black out and print the above area. Reference numeral 909 denotes an element describing an instruction to make the above area blank (non-printing) and to print the blanked area. Reference numeral 910 denotes an element describing an instruction to print an error on a sheet of paper.

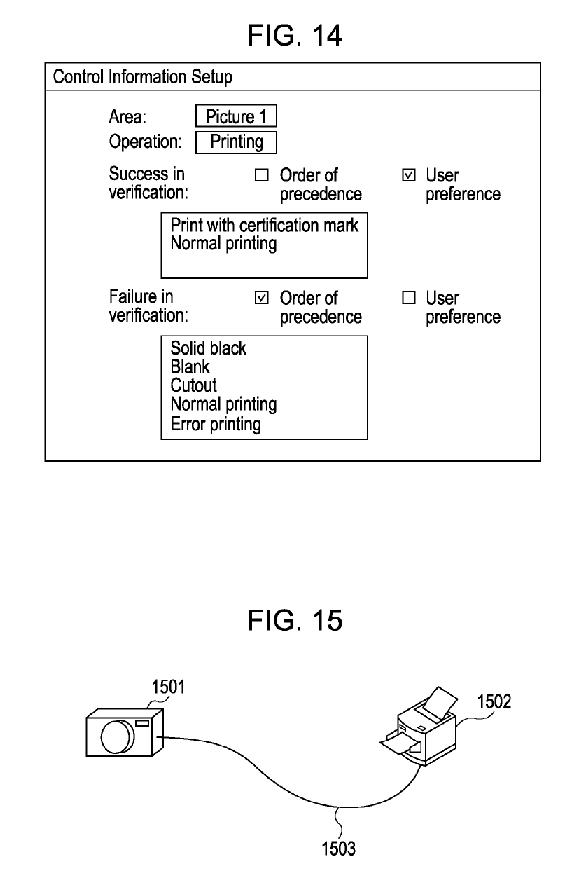

As for the control information shown in FIGS. 8 and 9, the signer determines how to process the image. Accordingly, “Control Information Setup” window shown in FIG. 14 is prepared by the electronic document generating apparatus 301 and the user, who is the signer, sets the control information in the “Control Information Setup” window. Alternatively, the user, who is the signer, may select one kind of the control information from multiple kinds of the control information, which are stored, and may add the selected kind of the control information to the electronic document.

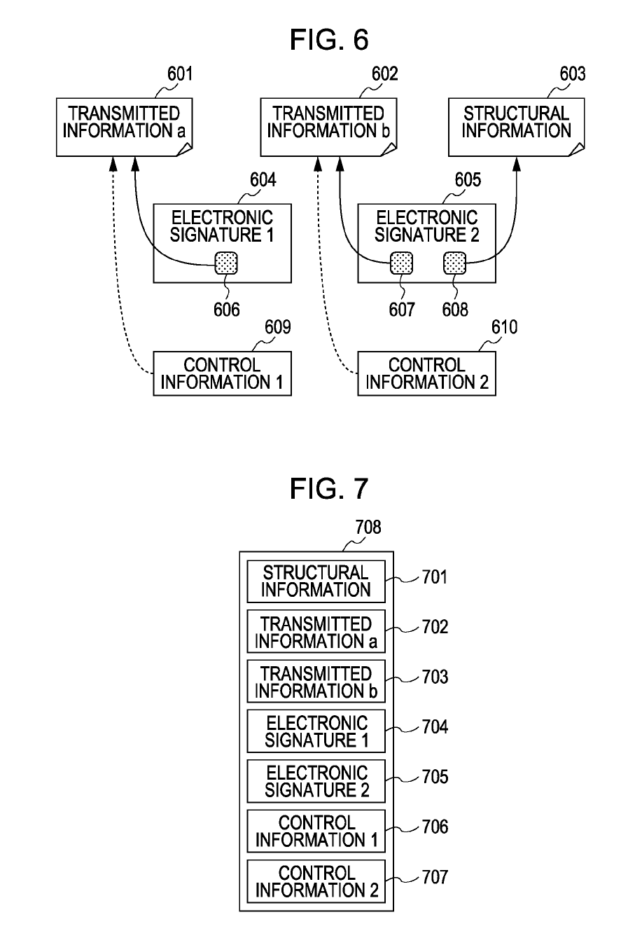

The information adder 308 in FIG. 3 will now be described with reference to FIG. 6.

An example in which the electronic signature is affixed to the transmitted information for the color picture area 503 and the transmitted information for the character area 506, in the image data in FIG. 5B, is shown in the first embodiment of the present invention. However, the present invention is not limited to this example and the electronic signature may be affixed to all the transmitted information and the structural information.

Referring to FIG. 6, reference numeral 601 denotes transmitted information a for the color picture area 503 in FIG. 5B and reference numeral 602 denotes transmitted information b for the character area 506 in FIG. 5B. Reference numeral 603 denotes structural information for the entire electronic document (the entire image corresponding to one screen). Reference numeral 604 denotes an electronic signature affixed to the transmitted information a for the color picture area 503 generated in the electronic signature generator 307 and reference numeral 605 denotes an electronic signature affixed to the transmitted information b for the character area 506. The electronic signature has pointer information embedded therein, pointing to the transmitted information and the structural information corresponding to the data to which the electronic signature is affixed (hereinafter referred to as signed data). In the example shown in FIG. 6, pointer information 606 pointing to the transmitted information a 601, which is the signed data, is embedded in the electronic signature 604. The electronic signature may not have one-to-one correspondence to the signed data. For example, both pointer information 607 pointing to the transmitted information b 602, which is the signed data, and pointer information 608 pointing to the structural information 603 representing the structure of the entire electronic document may be embedded in the electronic signature 605.

The information adder 308 adds control information 1 609 and control information 2 610 generated in the control information generator 318 to the transmitted information a 601 and the transmitted information b 602 in FIG. 6, respectively.

The control information may be individually added to the transmitted information, as in the example shown in FIG. 6, or one piece of the control information may be added to multiple pieces of the transmitted information. Alternatively, one piece of the control information may be added to the entire electronic document, and the control information may be targeted at all the transmitted information or part of the transmitted information in the electronic document. Specifically, the control information may be individually added to the transmitted information if the signer intends to individually control the transmitted information, and the control information may be added to the target transmitted information if the signer intends to control the entire electronic document or part of the transmitted information.

The electronic document integrator 309 in FIG. 3 will now be described with reference to FIGS. 6 and 7.

The transmitted information a 601, the transmitted information b 602, the structural information 603, the electronic signature 604, the electronic signature 605, the control information 1 609, and the control information 2 610 in the structured data shown in FIG. 6 form a collection of individual XML data or binary data of an image. The electronic document integrator 309 generates an electronic document in which the individual data is integrated. The electronic document can be integrated by a suitable archiving technology, for example, in a ZIP format.

FIG. 7 is a diagram schematically showing an example of an integrated electronic document 708 in which the electronic document integrator 309 integrates the structured data, the electronic signatures, and the control information. The integrated data is not limited to one file shown in FIG. 7. The individual data may be separate files to which a link is established. Alternatively, the user may select the individual data to be integrated.

The electronic document transmitter 310 transmits the data integrated by the electronic document integrator 309 to the electronic document processing apparatus 302 as the electronic document 311.

Next, the functional blocks in the electronic document processing apparatus 302 will be described.

The electronic document receiver 312 receives the electronic document 311 transmitted from the electronic document transmitter 310.

The electronic document decomposer 313 decomposes the elements 701 to 707 in the electronic document 311, which are integrated into the electronic document 708 in FIG. 7, to acquire the individual data including the transmitted information, the structural information, the electronic signature, and the control information, as shown in FIG. 6.

The electronic signature verifier 315 in FIG. 3 will now be described with reference to FIGS. 3, 7, and 18.

The electronic signature verifier 315 can use any suitable method of verifying an electronic signature to verify the electronic signature affixed to the signed area in the electronic document 311.

In the process of verifying the electronic signature in FIG. 18, the hash process 1808 is performed to transmitted information a 702, which is the input data 1807 and which is the signed data in the integrated electronic document 708 in FIG. 7 to calculate the digest value 1809, which is fixed length data.

The electronic signature verifier 315 determines whether the digest value 1809 coincides with the signature data 1810 decrypted with the public key 1811. The information concerning the public key 1811 is stored in advance in the electronic document processing apparatus 302.

The control information interpreter 316 and the action performer 317 in FIG. 3 will now be described.

The control information interpreter 316 refers to the control information in the electronic document to determine whether or not an action can be actually performed to the target signed area. The action performer 317 performs the action determined to be allowable by the control information interpreter 316.

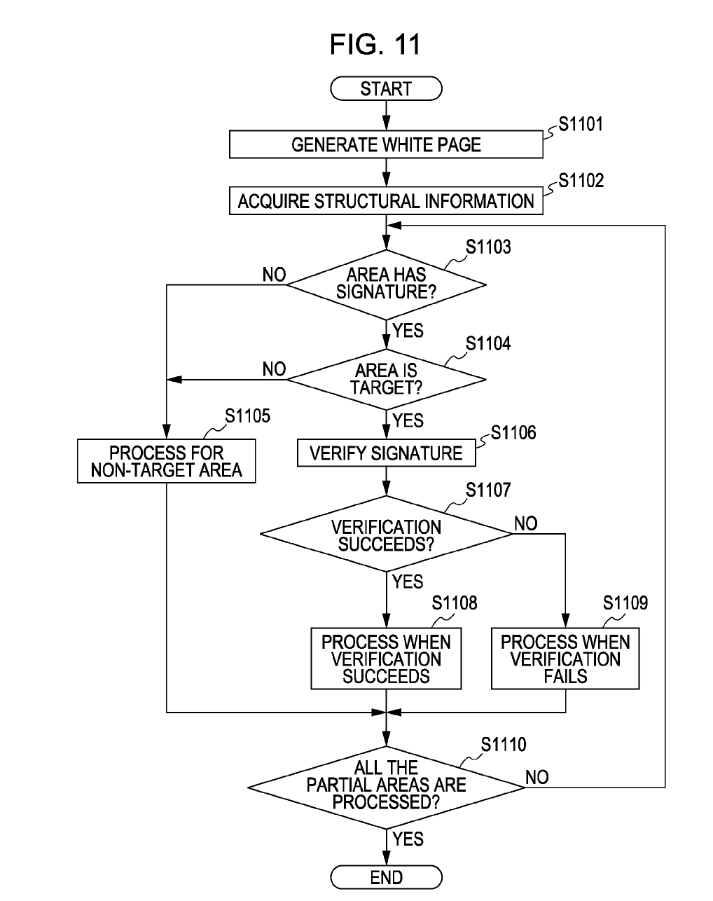

An example in which the control information shown in FIG. 8 is applied when the electronic document 311 in FIG. 5A, generated by the electronic document generating apparatus 301, is printed with the printer will be described with reference to FIG. 11. FIG. 11 is a flowchart showing a process performed by the control information interpreter 316 and the action performer 317. The transmitted information a described in the element 801 in FIG. 8 corresponds to the partial image (color raster data) in the color picture area 503 in FIG. 5. It is presumed in this example that the electronic signature is affixed only to the color picture area 503.

Referring to FIG. 11, in Step S1101, the process generates image data representing a blank page as the image data to be transmitted to the printer in order to print the electronic document.

In Step S1102, the process acquires structural information from the electronic document 311. The partial areas described in the structural information are sequentially targeted at in the steps subsequent to Step S1102.

In Step S1103, the process determines whether the process of generating the electronic signature is performed to the transmitted information associated with the target partial area. If the electronic signature is generated (“Yes” in Step S1103), the process proceeds to Step S1104. If the electronic signature is not generated (“No” in Step S1103), the process proceeds to Step S1105.

In Step S1104, the process determines whether the transmitted information associated with the target partial area is to be controlled. This determination can be made on the basis of the element 801 in FIG. 8 or the element 901 in FIG. 9. If the transmitted information is to be controlled (“Yes” in Step S1104), the process proceeds to Step S1106. If the transmitted information is not to be controlled (“No” in Step S1104), the process proceeds to Step S1105.

In Step S1105, the process performs a process for a non-target area to the transmitted information associated with the target partial area.

According to the first embodiment of the present invention, the content of the transmitted information is rendered on the image information of a page to be transmitted to the printer. For example, if the transmitted information is color raster data, the raster pixels in the color raster data are copied into the corresponding area in the image of one page. If the transmitted information is vector data, vectors are drawn on the image of one page in accordance with the vector data.

In Step S1106, the process verifies the electronic signature affixed to the target partial area.

In Step S1107, the process determines whether the verification of the electronic signature in Step S1106 succeeds. If the process determines that the verification of the electronic signature in Step S1106 succeeds (“Yes” in Step S1107), the process proceeds to Step S1108. If the process determines that the verification of the electronic signature in Step S1106 fails (“No” in Step S1107), the process proceeds to Step S1109.

In Step S1108, the process performs a process when the verification of the electronic signature affixed to the transmitted information described in the control information succeeds.

In Step S1108, when the verification of the electronic signature succeeds, rendering is performed, as in Step S1105, so that the partial area is normally printed as the action following the instruction 804 to print the target image, in FIG. 8.

In Step S1109, the process performs a process when the verification of the electronic signature affixed to the transmitted information described in the control information fails.

In Step S1109, when the verification of the electronic signature fails, rendering is performed so that the partial area is blacked out, as the action following the instruction 806 to black out and print the target image, in FIG. 8.

In Step S1110, the process determines whether all the partial areas are processed. If the process determines that all the partial areas are processed (“Yes” in Step S1110), the process is terminated. If the process determines that the partial areas that are not processed exist (“No” in Step S1110), the process goes back to Step S1103 and repeats the above steps.

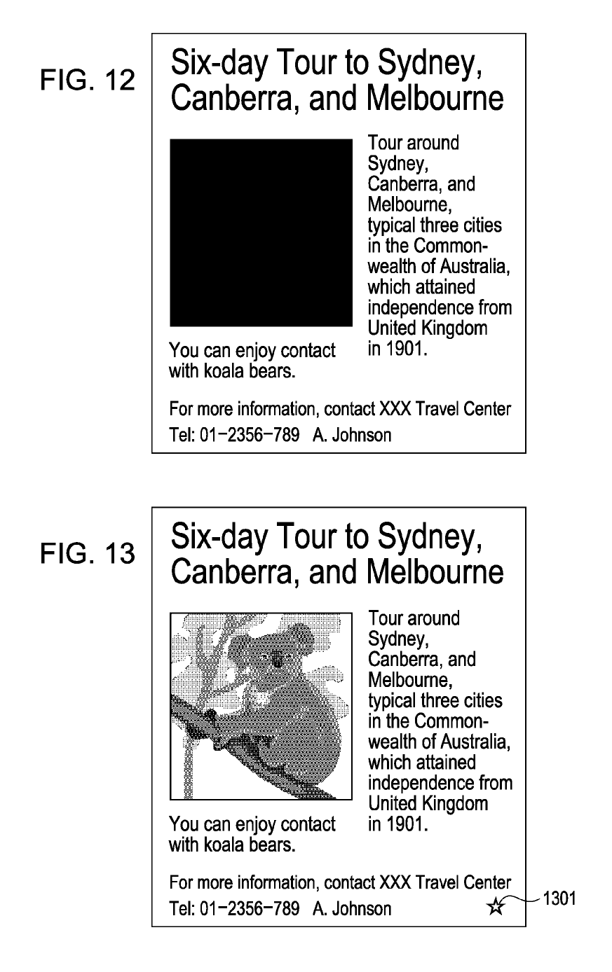

If the electronic document is not altered (e.g., not falsified), a print having the same appearance as the image in FIG. 5A is produced. In an embodiment, if the data in the color picture area 503 in the electronic document is altered (e.g., falsified), the verification in Step S1106 of the electronic signature affixed to the partial area fails and the partial area is blacked out as the action in Step S1109 when the verification of the electronic signature fails. In this case, a print shown in FIG. 12 is produced. Consequently, the process as intended by the signer can be performed as postprocessing of the verification of the electronic signature both in the case where the verification of the electronic signature succeeds and in the case where the verification of the electronic signature fails.

An example in which the control information shown in FIG. 9 is applied when the electronic document 311 in FIG. 5A, generated by the electronic document generating apparatus 301, is printed with the printer will be described.

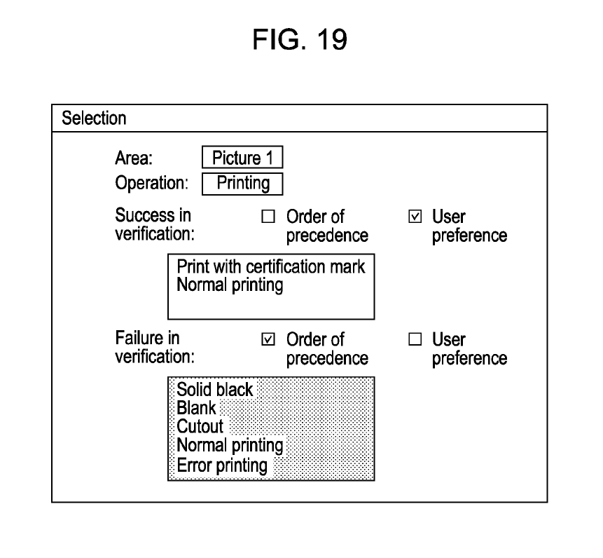

If the electronic document is not altered, a selection window is displayed, allowing the user to select the instruction 904 to print the image with the certification mark or the instruction 905 to normally print the image. This selection window can be realized with the monitor 202 when the host computer 201 is applied to the electronic document processing apparatus 302. FIG. 19 shows an example of “Selection” window. Using the “Selection” window in FIG. 19, the user can select the actions that are allowed to be performed if the verification of the electronic signature succeeds. The present invention is not limited to the selection shown with respect to the window illustrated in FIG. 19 and any suitable selection of actions from which the user can select may be displayed.

The image is printed in a manner selected by the user. FIG. 13 shows an output example when the user selects the printing with the certification mark. Referring to FIG. 13, reference numeral 1301 denotes a certification mark.

If the data in the color picture area 503 is altered (e.g., falsified), the control information in FIG. 9 is applied to the signed areas in the entire electronic document and an action following the description 906 when the verification fails is performed. In this case, the performance of the apparatus (mainly, the electronic document processing apparatus 302) performing the action is checked to select an instruction that the apparatus can actually perform, among the instructions 907 to 910. Specifically, it is determined whether an output unit of the apparatus has a cutter and whether the apparatus has an ability to cut out part of the output sheet of paper. If the apparatus has the ability to cut out part of the output sheet of paper, the first instruction 907 is followed. If the apparatus does not have a cutter, it is determined whether the apparatus has an ability to black out an area in the second instruction 908 and whether the apparatus has an ability to make an area blank in the third instruction 909. As soon as the ability of the apparatus is found, the action in accordance with the ability is selected. If no instruction can be followed, an error indication is printed, instead of printing the document, to indicate the error to the user.

Consequently, the process reflecting the intention of the signer can be performed as postprocessing of the verification of the electronic signature both in the case where the verification of the electronic signature succeeds and in the case where the verification of the electronic signature fails.

According to the first embodiment of the present invention, when the signer affixes the electronic signature to the electronic document (for example, an image including multiple partial images), the selected action (control information) for the electronic document in accordance with the result of the verification of the electronic signature, desired by the signer, is added to the electronic document (the partial image and the electronic signature). The apparatus performing the action for the electronic document can control the process as intended by the signer on the basis of the action (control information), after the verification of the electronic signature is terminated.

Second Exemplary Embodiment

FIG. 15 schematically shows a system according to a second embodiment of the present invention. Referring to FIG. 15, the system includes a digital camera 1501 capable of storing a captured image in a memory card or the like included in the digital camera 1501 as digital data. The system also includes a printer 1502 that is connectable to the digital camera 1501 via a cable 1503 or by radio waves to print the image data in the digital camera 1501. The system according to the second embodiment differs from the system according to the first embodiment in that the electronic document generating apparatus 301 and the electronic document processing apparatus 302 are replaced with an image capturing apparatus 1601 and a printing apparatus 1602. The processes according to the second embodiment are similar to those in the first embodiment.

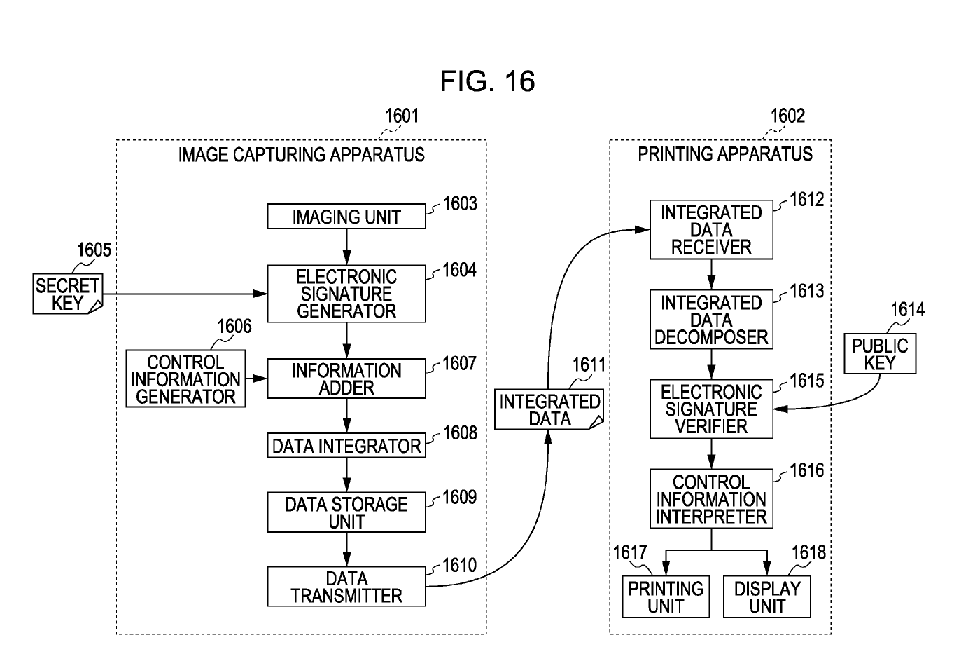

FIG. 16 is a block diagram showing an example of the functional configuration according to the second embodiment of the present invention.

An imaging unit 1603 in the image capturing apparatus 1601 captures a subject to generate image data. An electronic signature generator 1604 uses a secret key 1605 to generate an electronic signature for the image data. The secret key 1605 may be stored in the image capturing apparatus 1601 or may be loaded from an external storage medium into the image capturing apparatus 1601.

A control information generator 1606 generates control information corresponding to an action in accordance with the image data and the verification result of the electronic signature affixed to the image data. An information adder 1607 adds the electronic signature and the control information to the image data. A data integrator 1608 integrates the image data, the electronic signature, and the control information, as in the first embodiment.

A data storage unit 1609 stores the data integrated in the data integrator 1608. A data transmitter 1610 transmits integrated data 1611 to the printing apparatus 1602. A integrated data receiver 1612 communicates with the data transmitter 1610 to receive the integrated data 1611.

A integrated data decomposer 1613 decomposes the integrated data 1611 received by the integrated data receiver 1612 to acquire the image data, the electronic signature, and the control information. An electronic signature verifier 1615 uses a public key 1614 to verify the electronic signature.

A control information interpreter 1616 interprets the control information to instruct an action in accordance with the verification result of the electronic signature affixed to the image data. A printing unit 1617 prints the image data in accordance with the instruction issued from the control information interpreter 1616. A display unit 1618 displays the image data in accordance with the instruction issued from the control information interpreter 1616.

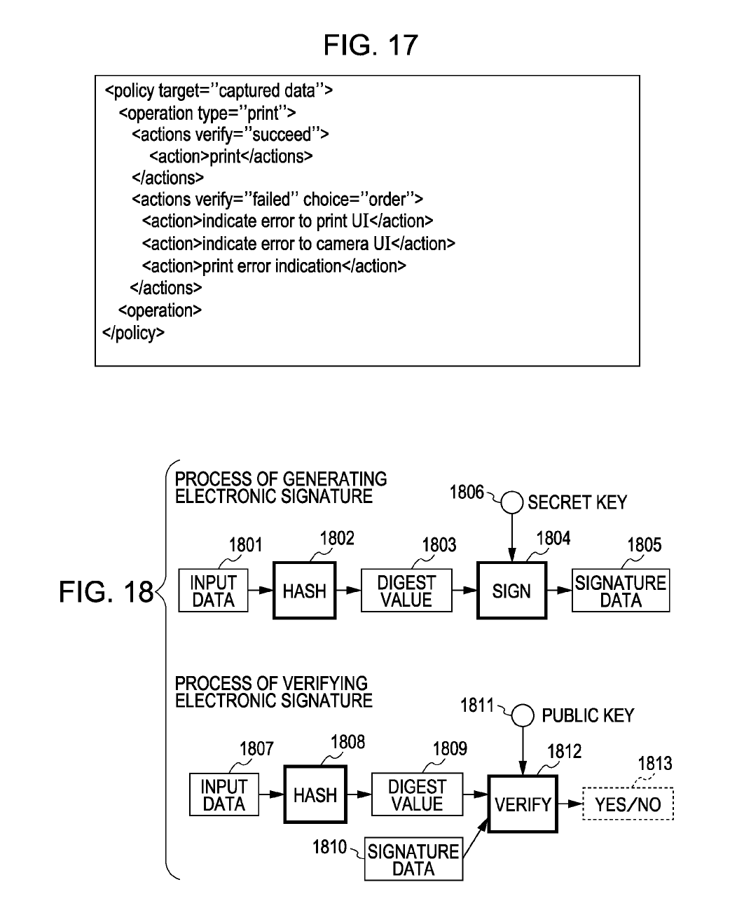

For example, the electronic signature of a photographer (signer) is affixed to the image captured by the image capturing apparatus 1601 according to the second embodiment of the present invention, and the control information shown in FIG. 17 is added to the image. The integrated data including the image data, the electronic signature, and the control information is stored in, for example, a memory card in the image capturing apparatus 1601.

Next, the image capturing apparatus 1601 is connected to the printing apparatus 1602 in order for a user to print the data in the image capturing apparatus 1601 with the printing apparatus 1602. Specifying printing in a display unit in the image capturing apparatus 1601 or the printing apparatus 1602 causes the data to be loaded into the printing apparatus 1602 to verify the electronic signature affixed to the image data and to interpret the control information.

If the image data is not falsified, normal printing is performed in accordance with a description when the verification of the electronic signature succeeds, shown in FIG. 17. If the image data is falsified, the verification of the electronic signature fails and the following actions are performed in accordance with descriptions when the verification of the electronic signature fails, shown in FIG. 17. 1. If the printing apparatus 1602 includes a display unit, an indication that the verification of the electronic signature fails is displayed in the display unit in the printing apparatus 1602. 2. If the display unit of the connected image capturing apparatus 1601 is available, the indication that the verification of the electronic signature fails is displayed in the display unit in the image capturing apparatus 1601. 3. If both the above actions are not available, the indication that the verification of the electronic signature fails is printed with the printing apparatus 1602.

Consequently, the process as intended by the signer can be performed as postprocessing of the verification of the electronic signature both in the case where the verification of the electronic signature succeeds and in the case where the verification of the electronic signature fails.

According to the second embodiment of the present invention, when the photographer (signer) affixes the electronic signature to the image data captured by the image capturing apparatus, the selected action (control information) for the image data in accordance with the result of the verification of the electronic signature, desired by the photographer, is added to the image data. The apparatus performing the action for the image data can control the process as intended by the photographer on the basis of the action (control information), after the verification of the electronic signature is terminated.

Third Exemplary Embodiment

According to a third embodiment of the present invention, an electronic signature may be affixed also to the control information, and the action for the electronic document may be controlled in accordance with the result of the verification of the electronic signature affixed to the control information.

For example, when a critical action is performed to the electronic document to which the electronic signature is affixed on the basis of the control information, the reliability of the control information becomes important. Accordingly, the affixture of the electronic signature to the control information can ensure the reliability of the control information.

If the verification of the electronic signature affixed to the control information succeeds, the critical action is performed. If the verification of the electronic signature affixed to the control information fails, a description of a relatively less critical action is included in the control information.

Consequently, the process as intended by the signer can be performed as postprocessing of the verification of the electronic signature in the apparatus processing the electronic document.

According to the first to third embodiments of the present invention, it is possible to control the process as intended by the signer on the basis of the result of the verification of the electronic signature affixed to the electronic document.

Other Exemplary Embodiments

The image data according to the present invention is not limited to the electronic document including characters and picture images. The image data may include only an image compressed in, for example, Joint Photographic Experts Group (JPEG) format or may include only characters described in ASCII codes.

The actions for the image data according to the present invention are not limited to the display and printing. The image data may be read out or edited.

According to the present invention, it is enough to associate the control information, the electronic signature, the structural information, and so on with each other with respect to the positional information. The control information, the electronic signature, the structural information, and so on may not be integrated into one or more files, unlike the example shown in FIG. 7.

The present invention is not limited to the apparatus and method that realize the above embodiments. The present invention can be embodied by supplying the program code of software realizing the functions according to the above embodiments to the computer (or the CPU or the micro processing unit (MPU)) in the system or the apparatus, the computer in the system or apparatus operating the various devices in accordance with the program code.

In this case, the program code itself realizes the functions of the embodiments described above. The present invention is applicable to the program code and means for supplying the program code to the computer, specifically, to the storage medium having the program code stored therein.

The storage medium supplying the program code may be any storage medium, such as a floppy disc (registered trademark), a hard disk, an optical disk, a magneto-optical disc, a CD-ROM, a magnetic tape, a nonvolatile memory card, or a ROM.

The computer that controls the various devices only in accordance with the supplied program code realizes the functions of the embodiments described above. In addition, the present invention is applicable to the program code also when the above embodiments are realized by the program code that is executed together with the operating system (OS) or another application software running on the computer.

Alternatively, the CPU or the like which is provided in an expansion board included in the computer or in an expansion unit connected to the computer may execute all or part of the processing based on instructions in the program code to realize the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-262655 filed Sep. 9, 2005, which is hereby incorporated by reference herein in its entirety.

What is claimed is:

1. A method comprising:
generating an electronic signature to be affixed to image data;
generating control information used for controlling an action for the image data based on a result of verification of the electronic signature; and
integrating the image data, the electronic signature, and the control information to generate integrated data and transmitting the integrated data.

2. The method according to claim 1,
wherein the image data is divided into a plurality of partial image data areas, the image data including data corresponding to the plurality of partial image data areas, and
wherein the control information is generated for at least one of the partial image data areas.

3. The method according to claim 2,
wherein the control information is generated in the unit of the partial image data area.

4. The method according to claim 1,
wherein the control information includes at least one of first action information performed if the verification of the electronic signature succeeds and second action information performed if the verification of the electronic signature fails.

5. The method according to claim 4,
wherein the first action information and the second action information are associated with at least one of printing, displaying, editing, or reading out of an image.

6. A method comprising:
receiving image data, an electronic signature affixed to the image data, and control information;
verifying the electronic signature based on the image data and the electronic signature; and
controlling an action for the image data based on the control information and a result of verification of the electronic signature.

7. The method according to claim 6,
dividing the image data into a plurality of partial image data areas, the image data including data corresponding to the plurality of partial image data areas;
associating the electronic signature and the control information to at least one of the partial image data areas; and
controlling the action for the at least one of the partial image data areas based on the control information associated with the at least one of the partial image data areas.

8. The method according to claim 7, wherein the electronic signature and the control information associated with the at least one of the partial image data areas are added to the data corresponding to the at least one of the partial image data areas.

9. An image processing apparatus comprising:
an electronic signature generating unit that generates an electronic signature to be affixed to image data;
a control information generating unit that generates control information used for controlling an action for the image data based on a result of verification of the electronic signature; and
a transmitting unit that integrates the image data, the electronic signature, and the control information to generate integrated data and transmits the integrated data.

10. The image processing apparatus according to claim 9,
wherein the image data is divided into a plurality of partial image data areas, the image data including data corresponding to the plurality of partial image data areas, and
wherein the control information generating unit generates the control information for at least one of the partial image data areas.

11. The image processing apparatus according to claim 10,
wherein the control information generating unit generates the control information in the unit of the partial image data area.

12. The image processing apparatus according to claim 9,
wherein the control information includes at least one of first action information performed if the verification of the electronic signature succeeds and second action information performed if the verification of the electronic signature fails.

13. The image processing apparatus according to claim 12,
wherein the first action information and second action information are associated with at least one of printing, displaying, editing, or reading out of an image.

14. An image processing apparatus comprising:
a receiving unit that receives image data, an electronic signature affixed to the image data, and control information;
an electronic signature verifying unit that verifies the electronic signature based on the image data and the electronic signature; and
a controlling unit that controls an action for the image data based on the control information and a result of verification of the electronic signature.

15. The image processing apparatus according to claim 14,
wherein the image data is divided into a plurality of partial areas, the image data including data corresponding to the plurality of partial areas,
wherein the electronic signature and the control information are associated with at least one of the partial areas, and
wherein the controlling unit is capable of controlling the action for the data corresponding to the at least one of the partial areas based on the control information associated therewith and a result of verification of the electronic signature associated therewith.

16. The image processing apparatus according to claim 15, wherein the electronic signature and the control information associated with the at least one of the partial areas are added to the data corresponding to the at least one of the partial image data areas.

17. A computer-readable storage medium storing instructions which, when executed by a computer, causes the computer to perform operations comprising:
generating an electronic signature to be affixed to image data;
generating control information used for controlling an action for the image data based on a result of verification of the electronic signature; and
integrating the image data, the electronic signature, and the control information to generate integrated data.

18. The computer-readable storage medium of claim 17, wherein the instructions cause the computer to perform further operations comprising:
dividing the image data into a plurality of partial areas; and
generating control information for at least one of the plurality of partial areas.

19. A computer-readable storage medium storing instructions which, when executed by a computer, causes the computer to perform operations comprising:
receiving image data, an electronic signature associated with the image data, and control information associated with image data;
verifying the electronic signature based on the image data and the electronic signature; and
controlling an action for the image data based on the control information and a result of verification of the electronic signature.

20. The computer-readable storage medium of claim 19, wherein the instructions cause the computer to perform further operations comprising:
dividing the image data into a plurality of partial areas; and
adding an electronic signature and control information for at least one of the plurality of partial areas.
